(19) United States
(12) Patent Application Publication
(10) Pub. No.: US 2006/0120220 A1
(43) Pub. Date: Jun. 8, 2006

(54) Timepiece apparatus

(75) Inventor: Hin Kiu Lai, Kowloon Bay (HK)

Correspondence Address: LEYDIG VOIT & MAYER, LTD, 700 THIRTEENTH ST. NW, SUITE 300, WASHINGTON, DC, 20005-3960, US

(73) Assignee: Youngs Watch Company Limited, Kowloon Bay (HK)

(21) Appl. No.: 11/167,232

(22) Filed: Jun. 28, 2005

(30) Foreign Application Priority Data
Dec. 8, 2004 (CN) 200410052575.4

(51) Int. Cl. G04C 11/02

(52) U.S. Cl. 368/47

(57) ABSTRACT

A timepiece apparatus has a time base unit and a wristwatch co-operable with the time base unit for time adjustment. The time base unit includes a microcontroller unit (MCU) for operation and time keeping and a transmitter for transmitting a wireless signal indicative of the current time. The wristwatch includes an MCU for operation and time keeping, a display, and a receiver for receiving the wireless signal, whereupon the MCU will automatically, without the use of any key or button, adjust the time displayed based on the wireless signal to the current time. A detector preferably detects proximal placement of the wristwatch relative to the time base unit, before the transmitter and the receiver are activated.

The present invention relates to timepiece apparatus and a method of time adjustment using the same.

### BACKGROUND OF THE INVENTION

Time adjustment of timepieces, such as wristwatches and clocks, are usually carried out manually for example by turning a winding knob or pressing keys (or buttons) in a meticulous manner to set the right time. Radio controlled clocks based on radio frequency time signals broadcast by the local authorities are relatively easier to adjust (synchronize) time, but a sufficiently strong signal is usually needed and signal availability and/or strength is a concern in some places even if such areas are meant to be covered.

The subject invention seeks to mitigate or at least to alleviate at least some of these shortcomings or problems by providing new or improved timepiece apparatus and a method of time adjustment using the same.

### SUMMARY OF THE INVENTION

According to the invention, there are provided timepiece apparatus comprising a time base unit and a timepiece co-operable therewith for time adjustment;

the time base unit comprising:

a control device for operation and time keeping; and

a transmitter for transmitting a wireless signal indicative of the current time provided by the control device;

the timepiece comprising:

a control circuit for operation and time keeping;

a display for displaying time; and

a receiver for receiving said wireless signal, whereupon the control circuit will automatically, without the use of any key or button, adjust the time based on said signal to the current time.

Preferably, the timepiece apparatus include detecting means for detecting proximal placement between the timepiece and the time base unit, whereupon the transmitter and the receiver are activated.

More preferably, the detecting means comprises a switch provided at one of the time base unit and the timepiece for actuation by the other of the time base unit and the timepiece upon physical engagement between the time base unit and the timepiece.

It is preferred that the detecting means comprise two detectors provided at the time base unit and the timepiece respectively, the detectors being co-operable with each other for said detecting of proximal placement between the timepiece and the time base unit.

It is further preferred that one of the detectors comprises a radio frequency transmitter and the other detector comprises a radio frequency receiver.

Alternatively, one of the detectors comprises an infrared transmitter and the other detector comprises an infrared receiver.

Alternatively, one of the detectors comprises a magnet and the other detector comprises a magnetic sensor.

It is preferred that the transmitter comprises a radio frequency transmitter and the receiver comprises a radio frequency receiver.

It is preferred that the transmitter comprises an infrared transmitter and the receiver comprises an infrared receiver.

It is preferred that the transmitter comprises a magnetic signal transmitter and the receiver comprises a magnetic signal receiver.

In a preferred embodiment, the timepiece comprises a wristwatch.

In a preferred embodiment, the timepiece includes no key or button.

The invention also provides a method of time adjustment using the aforesaid timepiece apparatus, comprising:

placing the timepiece and the time base unit in close proximity;

detecting proximal placement between the timepiece and the time base unit;

activating the transmitter to transmit a wireless signal indicative of the current time;

activating the receiver to receive said wireless signal from the transmitter; and

adjusting the time of the timepiece automatically, without the use of any key or button, based on said signal to the current time.

### BRIEF DESCRIPTION OF DRAWINGS

The invention will now be more particularly described, by way of example only, with reference to the accompanying drawings, in which:

FIG. 1 is a functional block diagram of a timepiece of an embodiment of timepiece apparatus in accordance with the invention;

FIG. 2 is a schematic flow diagram illustrating the operation of the timepiece of FIG. 1;

FIG. 3 is a functional block diagram of a time base unit co-operating with the timepiece of FIG. 1;

FIG. 4 is a schematic flow diagram illustrating the operation of the time base unit of FIG. 3;

FIGS. 5 to 7 are front views of three examples of the timepiece of FIG. 1, showing a digital, an analogue or a combined digital/analogue display respectively;

FIG. 8 is a detailed circuit diagram of the timepiece of FIG. 1;

FIG. 9 is a front view of the time base unit of FIG. 3; and

FIG. 10 is a detailed circuit diagram of the time base unit of FIG. 3.

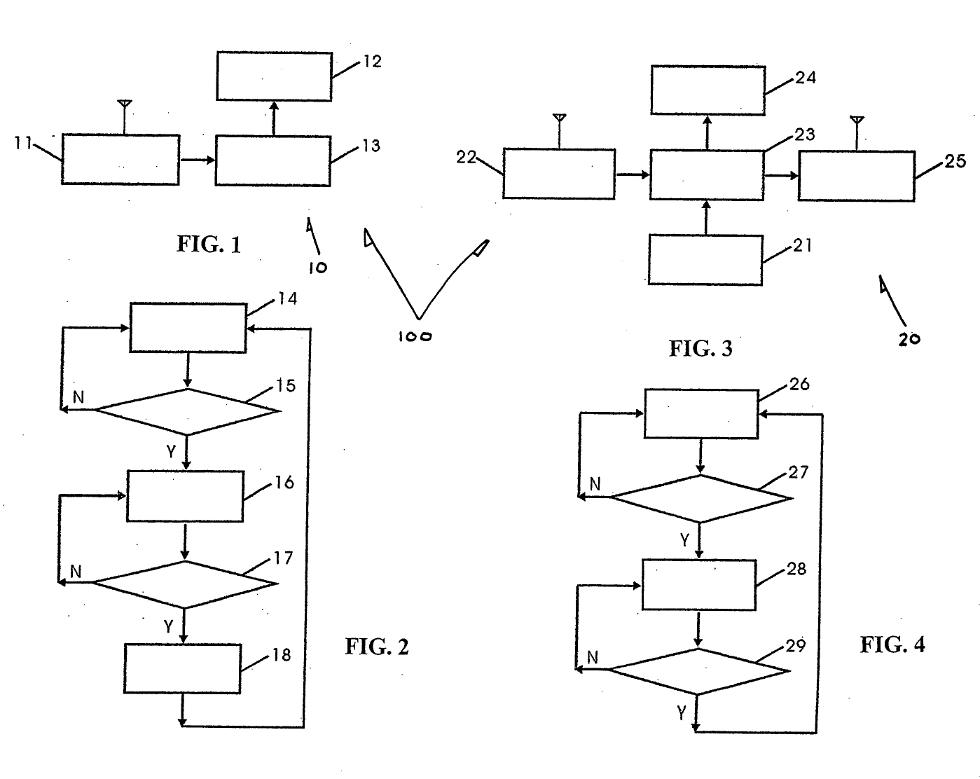

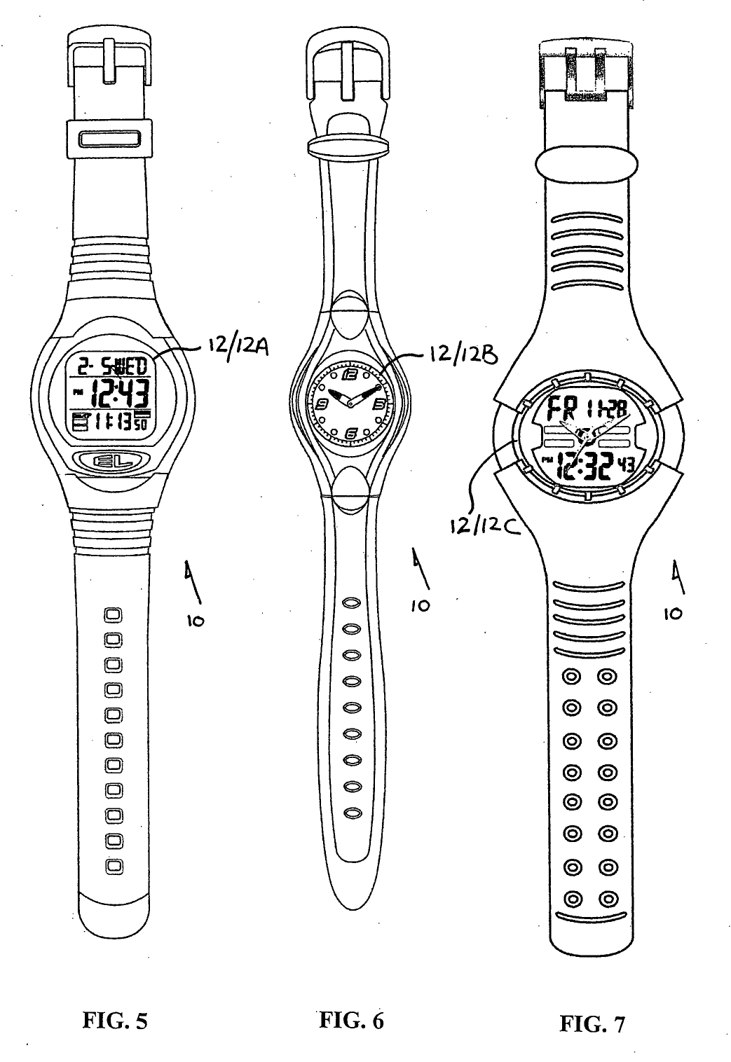

### DETAILED DESCRIPTION OF PREFERRED EMBODIMENT

Referring to the drawings, there is shown a timepiece apparatus 100 embodying the invention, which apparatus 100 comprise a time base unit 20 and a separate timepiece 10 co-operable therewith for time adjustment.

The time base unit 20, which is in itself a standalone clock, has a body 20A, an internal electronic operating circuit 20X incorporating an MCU (microprocessor control unit) 23 for operation and time keeping, and an LCD display 24 on the body 20A for displaying time, etc. The base unit 20 includes conventional keys or buttons 21 associated with the MCU 23 to enable input of control and data from a user.

An RF (radio frequency) radio clock signal receiver 22 of the operating circuit 20X receives and synchronizes with the official RF time/calendar signal broadcast by the local authority of the country or time zone concerned. The current time is shown on the display 24 under the control of the MCU 23. Alternatively, the time base unit 20 may be connected to the Internet for obtaining the correct time, through synchronization with the so called atomic clock. Or, the correct time may be set manually, on the presumption that the base unit 20 keeps time reasonably accurately.

The operating circuit 20X includes a RF transmitter 25 for transmitting a wireless RF signal indicative of the current time provided by MCU 23. Further included is a detector 20D, also associated with the MCU 23, for detecting proximal placement between the timepiece 10 and the time base unit 20, usually proximal placement of the former to the latter, whereupon the MCU 23 activates the RF transmitter 25 to transmit the said wireless signal or time sync signal.

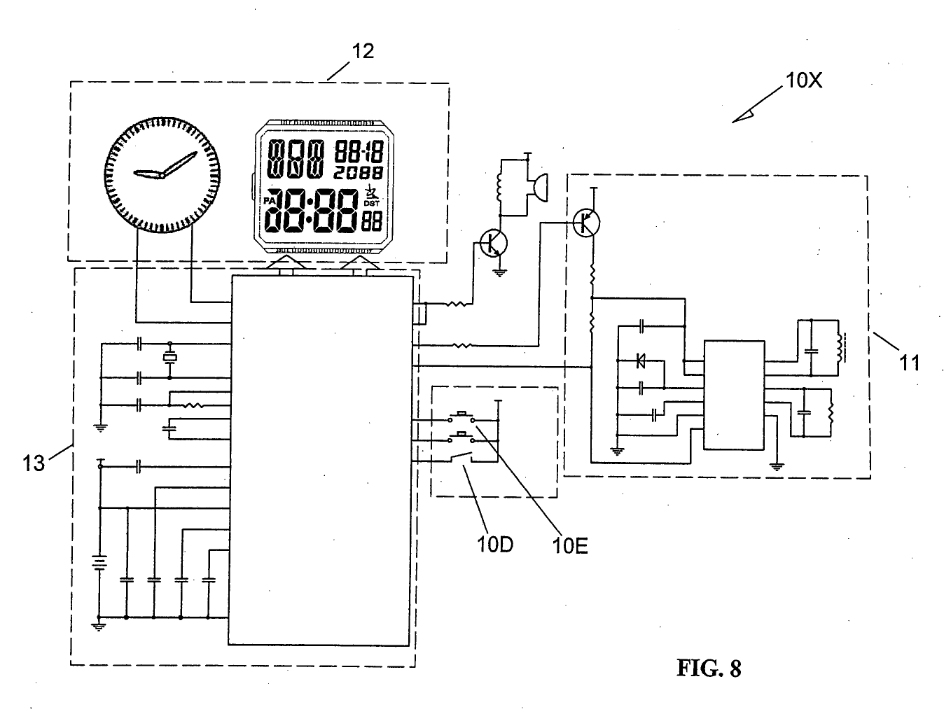

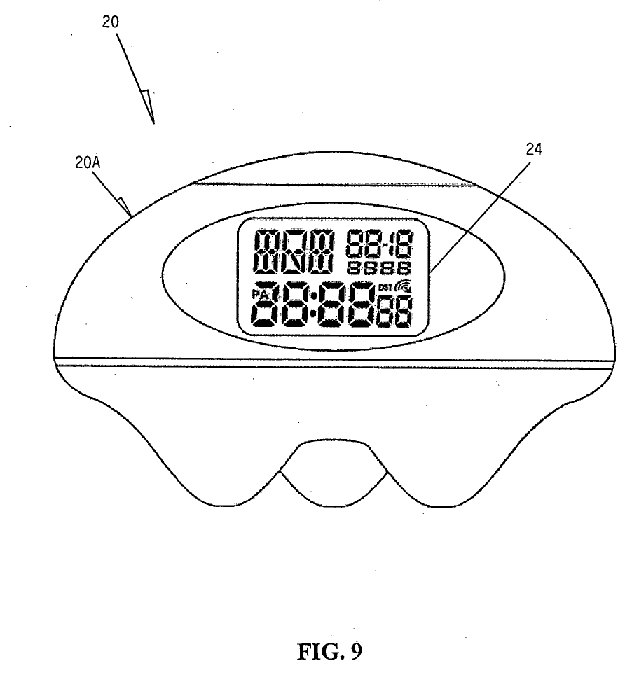

The timepiece 10 is a wristwatch 10 which has a case with straps, an internal electronic operating circuit 10X incorporating an MCU 13 for operation and time keeping, and an LCD display 12 for displaying time. The display 12 can be a digital display 12A, an analogue display 12B or a combined digital/analogue display 12C. In this particular embodiment, the wristwatch 10 does not have any external keys or buttons or a winding knob as it is controlled by the time base unit 20, though it includes two internal keys 10E inside the watch case (see FIG. 8).

For the purpose of time adjustment, the operating circuit 10X includes an RF receiver 11, connected to the MCU 13, which is tuned in with the RF transmitter 25 of the time base unit 20 for receiving the time sync signal therefrom. Upon the RF receiver receiving such a signal, the MCU 13 will automatically, without the use of any key or button, adjust the time based on the received signal to the current time.

The operating circuit 10X further includes a detector 10D, also associated with the MCU 13, which co-operates with the detector 20D of the time base unit 20 for the aforesaid detecting of proximal placement of the timepiece 10 to the time base unit 20, whereupon the MCU 13 activates the RF receiver 11 to receive the time sync signal.

In this particular embodiment, the detector 20D of the time base unit 20 takes the form of a permanent magnet (not shown) located in the body 20A and the wristwatch detector 10D is implemented by an internal reed switch 10D for sensing close proximity of the magnet when the wristwatch 10 is brought sufficiently near the time base unit 20. Upon closing, the reed switch 10D will trigger the MCU 13, e.g. by completing a power circuit thereof, for activating the RF receiver 11 to receive the time sync signal.

There are a number of possible ways for the time base unit 20 to detect the approach of the wristwatch 10. For example, another pair of the said magnet and reed switch may be employed with the magnet carried by the wristwatch 10 and the reed switch installed in the body 20A of the time base unit 20 for activating the RF transmitter 25.

As another example of the detecting means, a micro switch (not shown) may be located at the body 20A of the time base unit 20, preferably in a cradle for positioning the wristwatch 10 on the body 20A by the watch case, whose press knob is exposed for depression by the watch case upon physical engagement of the wristwatch 10 with the time base unit 20 i.e. placing of the watch case in the cradle.

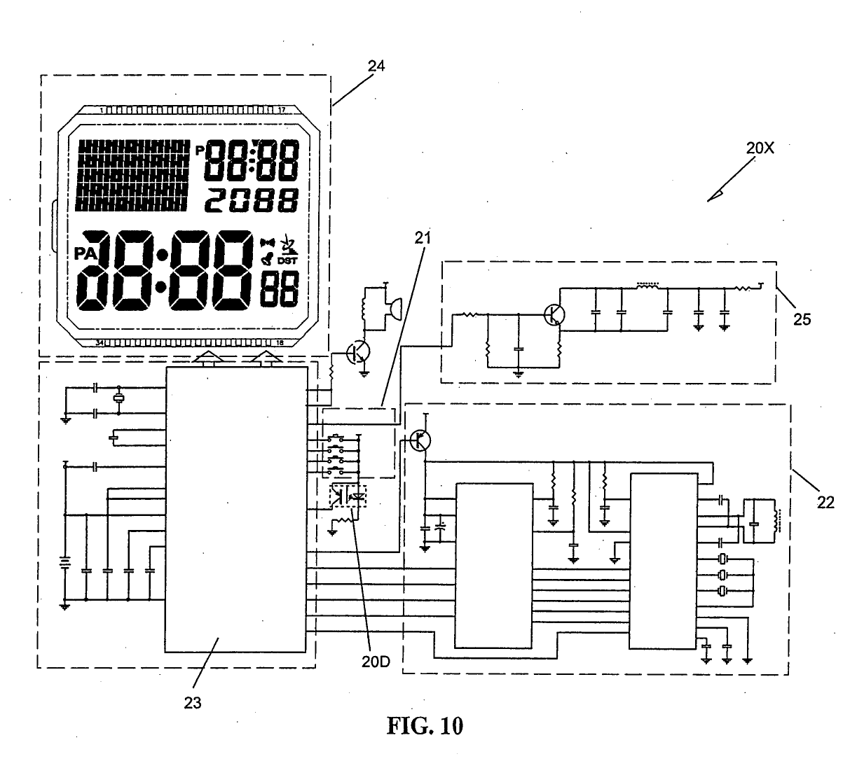

In a different embodiment, one of the detectors 10D/20D is provided by an RF (or infrared) transmitter and the other detector 20D/10D comprises an RF (or infrared) receiver for detecting a short-range signal emitted by the transmitter. As an alternative, the transmitter and receiver are preferably provided by a transceiver for detection in each direction, i.e. the time base unit 20 detecting the wristwatch 10 or vice versa, to reduce part count. The detector 20D as shown in FIG. 10 is in fact an infrared photo coupler, a kind of transceiver.

Referring to FIGS. 2 and 4, both the wristwatch 10 and the time base unit 20 normally indicate time on the displays 12 and 24 (Steps 14 and 26), and their operation for time adjustment is described below.

For the time base unit 20 in operation, its detector 20D operates repeatedly at regular intervals to monitor approach of the wristwatch 10. Upon detection of close placement of the wristwatch 10 (Step 27), the MCU 23 will retrieve the current time and insert it as content in a data packet according to a predetermined protocol, having a header including for example checksum, packet length and device identification code, and then supply the same to the RF transmitter 25. Under the control of the MCU 23, the transmitter 25 will modulate the data packet and then amplify and transmit it as said RF time sync signal (Step 28) at regular time intervals until removal of the wristwatch 10 is detected (Step 29). The normal operating mode then returns, i.e. time is displayed on the display 24 (Step 26).

With regard to the wristwatch 10, its detector 10D will likewise operate repeatedly at regular intervals to detect the time base unit 20. Upon detection (Step 15), the MCU 13 will activate the RF receiver 11 to receive the RF time sync signal (Step 16) and verify the received signal (Step 17), and to repeat receiving and verifying the signal if necessary until a correct signal has been received. The MCU 13 will finally extract the relevant time data from the received time sync signal and use the same to adjust, or align, the time to the current time (Step 18), and subsequently display the updated current time on the display 12 (Step 14).

The procedures of detecting close placement between the wristwatch 10 and the time base unit 20 can be omitted for simplicity, in which case the RF transmitter 25 and receiver 11 will need to operate continuously or be activated at regular intervals (say every 5-10 seconds) such that the timepiece apparatus 100 are almost always ready for time adjustment.

It is understood that the timepiece 10 may have one or two keys/buttons for user's control e.g. to set alarm or to turn on display backlight. Also, the display 12 may instead incorporate an LED or OLED (organic light emitting diode) or, in a different aspect, may indicate time by numeral or using hour/minute/second hands or a combination of both.

It is envisaged that the transmission of time sync signal from the time base unit 20 to the timepiece 10 may be accomplished by using any other suitable form of medium such as infrared beam or magnetic radiation, with the signal transmitter 25 and receiver 11 built accordingly.

The invention has been given by way of example only, and various other modifications and/or variations to the described embodiment may be made by persons skilled in the art without departing from the scope of the invention as specified in the accompanying claims.

1. A timepiece apparatus comprising a time base unit and a timepiece co-operable with the time base unit for time adjustment,
the time base unit comprising:
a control device for operation and time keeping, and
a transmitter for transmitting a wireless signal indicative of current time provided by the control device;
the timepiece comprising:
a control circuit for operation and time keeping,
a display for displaying time, and
a receiver for receiving the wireless signal, whereupon the control circuit automatically, without use of any key or button, adjusts the time displayed, based on the wireless signal, to the current time.

2. The timepiece apparatus as claimed in claim 1, including detecting means for detecting proximal placement between the timepiece and the time base unit, whereupon the transmitter and the receiver are activated.

3. The timepiece apparatus as claimed in claim 2, wherein the detecting means comprises a switch located at one of the time base unit and the timepiece for actuation by the other of the time base unit and the timepiece upon physical engagement between the time base unit and the timepiece.

4. The timepiece apparatus as claimed in claim 2, wherein the detecting comprises first and second detectors, located at the time base unit and the timepiece respectively, the first and second detectors being co-operable with each other for detecting the proximal placement between the timepiece and the time base unit.

5. The timepiece apparatus as claimed in claim 4, wherein one of the first and second detectors comprises a radio frequency transmitter and the other of the first and second detectors comprises a radio frequency receiver.

6. The timepiece apparatus as claimed in claim 4, wherein one of the first and second detectors comprises an infrared transmitter and the other of the first and second detectors comprises an infrared receiver.

7. The timepiece apparatus as claimed in claim 4, wherein one of the first and second detectors comprises a magnet and the other of the first and second detectors comprises a magnetic sensor.

8. The timepiece apparatus as claimed in claim 1, wherein the transmitter comprises a radio frequency transmitter and the receiver comprises a radio frequency receiver.

9. The timepiece apparatus as claimed in claim 1, wherein the transmitter comprises an infrared transmitter and the receiver comprises an infrared receiver.

10. The timepiece apparatus as claimed in claim 1, wherein the transmitter comprises a magnetic signal transmitter and the receiver comprises a magnetic signal receiver.

11. The timepiece apparatus as claimed in claim 1, wherein the timepiece comprises a wristwatch.

12. The timepiece apparatus as claimed in claim 1, wherein the timepiece is free of keys and buttons.

13. A method of time adjustment using the timepiece apparatus as claimed in claim 2, comprising:
placing the timepiece and the time base unit in close proximity;
detecting proximal placement between the timepiece and the time base unit;
activating the transmitter to transmit a wireless signal indicative of the current time;
activating the receiver to receive the wireless signal from the transmitter; and
adjusting the time displayed by the timepiece automatically, without use of any key or button, based on the wireless signal, to the current time.
